(19) United States
(12) Patent Application Publication
(10) Pub. No.: US 2020/0199005 A1
(43) Pub. Date: Jun. 25, 2020

(54) METHOD AND DEVICE FOR MANUFACTURING A GLASS ARTICLE, AND A POWDER FOR FORMING A BONDED BODY

(71) Applicant: Nippon Electric Glass Co., Ltd., Shiga (JP)

(72) Inventors: Kazuyuki TENYAMA, Shiga (JP); So SAKURAI, Shiga (JP)

(21) Appl. No.: 16/634,727

(22) PCT Filed: Sep. 3, 2018
(86) PCT No.: PCT/JP2018/032621

§ 371 Date: Jan. 28, 2020

(30) Foreign Application Priority Data
Sep. 4, 2017 (JP) 2017-169505

(51) Int. Cl. C03B 19/09; C03C 8/02

(52) U.S. Cl. CPC C03B 19/09; C03C 8/02

(57) ABSTRACT

Provided is a manufacturing method for a glass article, including: a filling step (S1) of interposing a powder (P), which is to be diffusion-bonded through heating, between a transfer container (7, 16) and a refractory brick (8a, 8b, 17a, 17b); a pre-heating step (S2) of heating the transfer container (7, 16) after the filling step (S1); and a molten glass supply step (S5) of, while heating the transfer container (7, 16), causing a molten glass (GM) to pass through an inside of the transfer container (7, 16) after the pre-heating step (S2). In this method, the molten glass supply step (S5) includes diffusion-bonding the powder (P) to form a bonded body (10, 20) configured to fix the transfer container (7, 16) to the refractory brick (8a, 8b, 17a, 17b).

### TECHNICAL FIELD

The present invention relates to a manufacturing method and manufacturing apparatus for a glass article including forming molten glass.

### BACKGROUND ART

As is well known, a sheet glass is used in a flat panel display, such as a liquid crystal display or an OLED display.

In Patent Literature 1, there is a disclosure of a manufacturing apparatus for a sheet glass. The manufacturing apparatus for a sheet glass includes: a melting bath serving as a supply source of molten glass; a fining bath arranged on a downstream side of the melting bath; a stirring bath arranged on a downstream side of the fining bath; and a forming device arranged on a downstream side of the stirring bath. The melting bath, the fining bath, the stirring bath, and the forming device are connected to each other through communicating passages.

The fining bath, the stirring bath, and the communicating passage configured to connect these baths are each formed of a container made of a platinum material. The container made of a platinum material has a dry film formed on an outer surface thereof, and is covered with a retaining member made of a refractory material. An alumina castable is filled between the dry film and the retaining member. The alumina castable forms an aqueous slurry through addition of water in an appropriate amount, and is filled between the dry film and the retaining member. The alumina castable is dried to be solidified, to thereby fix the container made of a platinum material.

### CITATION LIST

Patent Literature 1: JP 2010-228942 A

### SUMMARY OF INVENTION

### Technical Problem

Incidentally, before operation, the manufacturing apparatus for a sheet glass is preliminarily heated under the state in which the constituents, that is, the melting bath, the fining bath, the stirring bath, the forming device, and the communicating passages, are individually separated (hereinafter referred to as “pre-heating step”). In the pre-heating step, the container made of a platinum material is expanded owing to an increase in temperature. The manufacturing apparatus for a sheet glass is assembled by connecting the constituents after the container made of a platinum material is sufficiently expanded. After that, the molten glass generated in the melting bath is supplied to the forming device through the fining bath, the stirring bath, and the communicating passages to be formed into a sheet glass.

In the pre-heating step, although the container made of a platinum material is expanded, the container made of a platinum material is fixed to the retaining member with the solidified alumina castable. Therefore, the expansion is inhibited, and a large thermal stress acts on the container, which may result in breakage or deformation of the container.

The present invention has been made in view of the above-mentioned circumstances, and an object of the present invention is to provide a manufacturing method and manufacturing apparatus for a glass article that each permit expansion of a container made of a platinum material to the extent possible when the container is increased in temperature and that are each capable of fixing the container so as to prevent the container from shifting in position at the time of operation.

### Solution to Problem

In order to achieve the above-mentioned object, according to one embodiment of the present invention, there is provided a manufacturing method for a glass article including transferring molten glass by a transfer container made of a platinum material and coated with a refractory brick and forming the molten glass, the method comprising: a filling step of interposing a powder, which is to be diffusion-bonded through heating, between the transfer container and the refractory brick; a pre-heating step of heating the transfer container after the filling step; and a molten glass supply step of, while heating the transfer container, causing the molten glass to pass through an inside of the transfer container after the pre-heating step, wherein the molten glass supply step comprises diffusion-bonding the powder to form a bonded body configured to fix the transfer container to the refractory brick.

With such configuration, the powder capable of being diffusion-bonded is interposed between the transfer container and the refractory brick in the pre-heating step. When the transfer container is expanded in the pre-heating step, the powder can be fluidized between the transfer container and the refractory brick, and hence acts as a lubricant. With this, in the pre-heating step, a state in which the expansion of the transfer container is permitted is achieved, and hence a thermal stress that acts on the transfer container can be reduced to the extent possible.

Meanwhile, in the molten glass supply step, the powder is increased in temperature when the molten glass is caused to pass through the transfer container and the transfer container is heated, and diffusion bonding between the powders is activated. The “diffusion bonding” as used herein refers to a method involving bringing the powders into contact with each other to bond the powders to each other at a temperature condition equal to or less than the melting point of the powder through utilization of diffusion of atoms occurring between contact surfaces. When the powder is diffusion-bonded to form the bonded body in the molten glass supply step, the transfer container is fixed to the refractory brick by the bonded body so as not to move with respect to the refractory brick.

It is desired that a gap between the transfer container and the refractory brick in which the powder is filled in the filling step have a width of 7.5 mm or more. With such configuration, the action of the powder as a lubricant can be further improved. With this, a thermal stress to be generated in the transfer container in association with its expansion can be further reduced.

It is desired that the powder to be used in the filling step comprise aggregate having an average particle diameter of 0.8 mm or more. In addition, it is desired that the powder comprise alumina powder as a main component, and the powder may further comprise silica powder. The content of the silica powder in the powder may be adjusted depending on a temperature of the molten glass transferred by the transfer container. In addition, it is desired that the transfer container be fixed to the refractory brick by the bonded body at a temperature of 1,300° C. or more.

The bonded body may comprise a porous structure, and the molten glass supply step may comprise forming the bonded body comprising molten glass generated from the powder. With this, the gas barrier properties of the bonded body can be improved in the molten glass supply step, and contact between the transfer container made of a platinum material and oxygen can be reduced. Accordingly, the consumption of the transfer container owing to oxidation or sublimation can be reduced.

The transfer container may comprise a thermal spray film on an outer peripheral surface thereof, and the molten glass supply step may comprise impregnating the thermal spray film with the molten glass generated from the powder. In this case, it is preferred that the thermal spray film be a zirconia thermal spray film.

When the transfer container has the thermal spray film formed on the outer peripheral surface thereof as described above, contact between the transfer container made of a platinum material and oxygen can be reduced. Accordingly, the consumption of the transfer container made of a platinum material owing to oxidation or sublimation can be reduced. When, in the molten glass supply step, the molten glass is generated from the powder arranged between the transfer container and the refractory brick, and the thermal spray film is impregnated with the molten glass, the gas barrier properties of the thermal spray film can be further improved, and the consumption of the transfer container made of a platinum material owing to oxidation can be further reduced.

In order to achieve the above-mentioned object, according to one embodiment of the present invention, there is provided a manufacturing apparatus for a glass article, comprising: a transfer container made of a platinum material configured to transfer molten glass; and a refractory brick configured to cover the transfer container, wherein the manufacturing apparatus further comprises, between the transfer container and the refractory brick, a bonded body obtained by diffusion-bonding a powder.

### Advantageous Effects of Invention

According to the present invention, expansion of the container made of a platinum material is permitted to the extent possible when the container is increased in temperature, and the container can be fixed so as to prevent the container from shifting in position at the time of operation.

### BRIEF DESCRIPTION OF DRAWINGS

FIG. 1 is a side view for illustrating a manufacturing apparatus for a glass article.

FIG. 2 is a sectional view of a fining bath.

FIG. 3 is a sectional view taken along the line III-III of FIG. 2.

FIG. 4 is a side view of a glass supply passage.

FIG. 5 is a sectional view of the glass supply passage.

FIG. 6 is a sectional view of a transfer container.

FIG. 7 is a sectional view taken along the line VII-VII of FIG. 6.

FIG. 8 is a flowchart of a manufacturing method for a glass article.

FIG. 9 is a sectional view for illustrating a step of the manufacturing method for a glass article.

FIG. 10 is a sectional view for illustrating the step of the manufacturing method for a glass article.

FIG. 11 is a sectional view for illustrating the step of the manufacturing method for a glass article.

FIG. 12 is a sectional view for illustrating the step of the manufacturing method for a glass article.

FIG. 13 is a sectional view for illustrating the step of the manufacturing method for a glass article.

FIG. 14 is a sectional view of a fining bath according to another embodiment of the present invention.

FIG. 15 is a sectional view for illustrating a region A of FIG. 14 in an enlarged manner.

FIG. 16 is a sectional view of the fining bath.

FIG. 17 is a sectional view for illustrating a region B of FIG. 16 in an enlarged manner.

FIG. 18 is a sectional view of a fining bath according to still another embodiment of the present invention.

FIG. 19 is a perspective view of a first layer member.

FIG. 20 a perspective view of the first layer member.

FIG. 21 a perspective view of the first layer member.

FIG. 22 is a sectional view of a fining bath according to yet another embodiment of the present invention.

FIG. 23 is a sectional view of the fining bath in a filling step.

FIG. 24 is a sectional view of the fining bath in the filling step.

FIG. 25 is an enlarged sectional view of the fining bath.

FIG. 26 is an enlarged sectional view of the fining bath.

### DESCRIPTION OF EMBODIMENTS

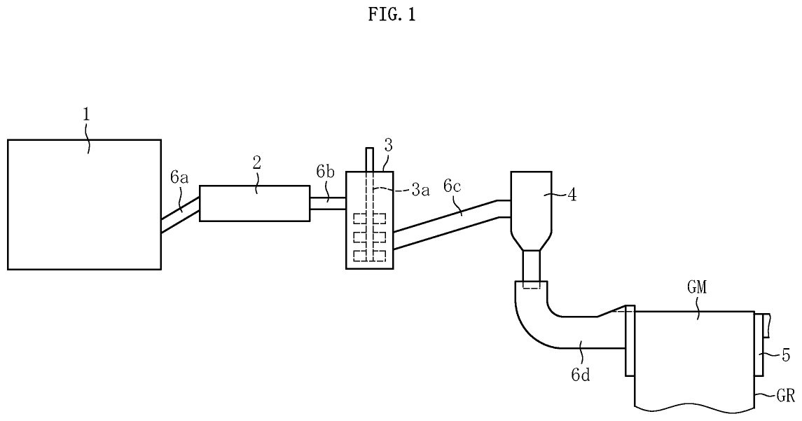

Embodiments of the present invention are described below with reference to the drawings. A manufacturing method and manufacturing apparatus for a glass article according to an embodiment (first embodiment) of the present invention are illustrated in FIG. 1 to FIG. 13.

As illustrated in FIG. 1, a manufacturing apparatus for a glass article according to this embodiment comprises: a melting bath 1; a fining bath 2; a homogenization bath (stirring bath) 3; a pot 4; a forming body 5; and glass supply passages 6a to 6d configured to connect these constituents 1 to 5 in the stated order from an upstream side. In addition thereto, the manufacturing apparatus further comprises: an annealing furnace (not shown) configured to anneal a sheet glass GR (glass article) formed by the forming body 5; and a cutting device (not shown) configured to cut the sheet glass GR after the annealing.

The melting bath 1 is a container for performing a melting step of melting loaded glass raw materials to obtain a molten glass GM. The melting bath 1 is connected to the fining bath 2 through the glass supply passage 6a.

The fining bath 2 is a container for performing a fining step of, while transferring the molten glass GM, degassing the molten glass GM through the action of a fining agent or the like. The fining bath 2 is connected to the homogenization bath 3 through the glass supply passage 6b.

The fining bath 2 comprises: a hollow transfer container 7 configured to transfer the molten glass GM from an upstream side to a downstream side; refractory bricks 8a and 8b configured to cover the transfer container 7; lid bodies 9 configured to close end portions of the refractory bricks 8a and 8b; and a bonded body 10 interposed between the transfer container 7 and each of the refractory bricks 8a and 8b.

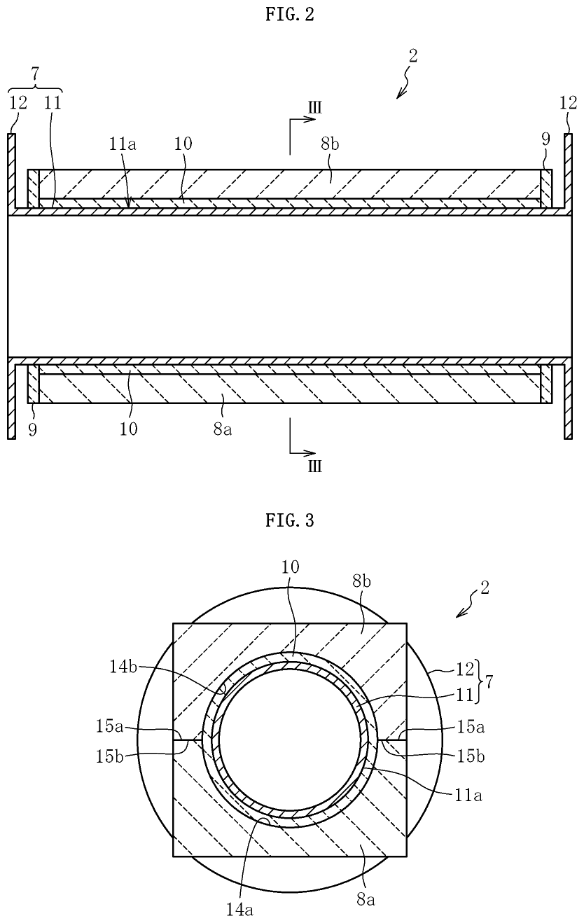

The transfer container 7 is made of a platinum material (platinum or a platinum alloy) into a tubular shape. However, the configuration of the transfer container 7 is not limited thereto, and the transfer container 7 only needs to have a structure having a space in an inside thereof through which the molten glass GM passes. As illustrated in FIG. 2 and FIG. 3, the transfer container 7 comprises: a tubular portion 11; and flange portions 12 arranged on both end portions of the tubular portion 11. The platinum material has a thermal expansion rate of, for example, from 1.3% to 1.5% when increased in temperature from 0° C. to 1,300° C. A thermal expansion rate R of the platinum material when the material is increased in temperature from 0° C. to 1,300° C. may be calculated by the equation: R=(L1−L0)/L0, where L0 represents a length (mm) of the material at 0° C., and L1 represents a length (mm) of the material at 1,300° C.

The tubular portion 11 has a tubular shape, but the configuration of the tubular portion 11 is not limited thereto. The inner diameter of the tubular portion 11 is desirably set to 100 mm or more and 300 mm or less. The thickness of the tubular portion 11 is desirably set to 0.3 mm or more and 3 mm or less. The length of the tubular portion 11 is desirably set to 300 mm or more and 10,000 mm or less. The dimensions of the tubular portion are not limited to the above-mentioned ranges, and are appropriately set depending on the type of the molten glass GM, the temperature, the scale of the manufacturing apparatus, and the like.

The tubular portion 11 may comprise, as required, a vent portion (vent pipe) configured to discharge a gas to be generated in the molten glass GM. In addition, the tubular portion 11 may comprise a partition plate (baffle plate) configured to change the flowing direction of the molten glass GM.

The flange portion 12 has a circular shape, but the shape of the flange portion 12 is not limited thereto. The flange portion 12 is, for example, formed integrally with the tubular portion 11 through deep drawing process. The flange portion 12 is connected to a power supply (not shown). The transfer container 7 of the fining bath 2 is configured to heat the molten glass GM flowing through an inside of the tubular portion 11 with resistance heat (Joule heat) generated by applying a current through the tubular portion 11 via the flange portions 12.

The refractory bricks 8a and 8b are each made of a highly zirconia-based refractory, a zircon-based refractory, or a fused silica-based refractory, but the materials for the refractory bricks 8a and 8b are not limited thereto. The “highly zirconia-based refractory” refers to a refractory comprising, in terms of mass %, 80% to 100% of ZrO₂. The highly zirconia-based refractory has a thermal expansion rate of, for example, from 0.1% to 0.3% when increased in temperature from 0° C. to 1,300° C. The highly zirconia-based refractory shows shrinkage at from 1,100° C. to 1,200° C. The highly zirconia-based refractory has a thermal expansion rate of, for example, from 0.6% to 0.8% when increased in temperature from 0° C. to 1,100° C., and a thermal expansion rate of, for example, from 0.0% to 0.3% when increased in temperature from 0° C. to 1,200° C. In addition, the zircon-based refractory has a thermal expansion rate of, for example, from 0.5% to 0.7% and the fused silica-based refractory has a thermal expansion rate of, for example, from 0.03% to 0.1% when increased in temperature from 0° C. to 1,300° C.

As illustrated in FIG. 2 and FIG. 3, the refractory bricks 8a and 8b comprise a plurality of refractory bricks, and in the illustrated example, comprise a first refractory brick 8a and a second refractory brick 8b. The first refractory brick 8a is configured to support the tubular portion 11 from a lower side of the tubular portion 11. The second refractory brick 8b is configured to cover an upper part of the tubular portion 11. The first refractory brick 8a and the second refractory brick 8b may each further be divided into a plurality of refractory bricks in a longitudinal direction thereof.

The first refractory brick 8a and the second refractory brick 8b have: surfaces (hereinafter referred to as “cover surfaces”) 14a and 14b configured to cover an outer peripheral surface 11a of the tubular portion 11; and surfaces (hereinafter referred to as “abutting surfaces”) 15a and 15b configured to abut on each other. The cover surfaces 14a and 14b also have a function of holding the outer peripheral surface 11a of the tubular portion 11.

As illustrated in FIG. 3, the cover surfaces 14a and 14b are each formed of an arc-like curved surface in a sectional view so that the outer peripheral surface 11a of the tubular portion 11 is covered therewith. The radii of curvature of the cover surfaces 14a and 14b are each set to be larger than the radius of the outer peripheral surface 11a of the tubular portion 11 so that a gap (accommodation space for the bonded body 10) is formed between the cover surfaces 14a and 14b and the outer peripheral surface 11a. A distance between each of the cover surfaces 14a and 14b and the outer peripheral surface 11a of the tubular portion 11 (a difference between the radius of the outer peripheral surface 11a and each of the radii of curvature of the cover surfaces 14a and 14b) is set to preferably 3 mm or more, more preferably 7.5 mm or more. From the viewpoint of preventing creep deformation of the tubular portion 11, the distance is set to preferably 50 mm or less, more preferably 20 mm or less.

Under the state in which the abutting surface 15a of the first refractory brick 8a and the abutting surface 15b of the second refractory brick 8b are brought into contact with each other, a tubular surface configured to cover the tubular portion 11 is formed by the cover surfaces 14a and 14b of the refractory bricks 8a and 8b (see FIG. 3).

As with the refractory bricks 8a and 8b, the lid body 9 is made of, for example, a highly zirconia-based refractory, a zircon-based refractory, or a fused silica-based refractory, but the material for the lid body 9 is not limited thereto. The lid body 9 is divided into a plurality of portions, and has a circular disc shape (circular ring shape) by combining the plurality of portions. The lid body 9 is configured to close each of the end portions of the refractory bricks 8a and 8b in the longitudinal direction when one surface of the lid body 9 in a thickness direction abuts on each of the end portions.

The bonded body 10 is formed by filling a powder P serving as a raw material (see FIG. 9 etc. described below) between the tubular portion 11 of the transfer container 7 and each of the refractory bricks 8a and 8b, and then diffusion-bonding the powder through heating. The “diffusion-bonding” refers to a method involving bringing the powders into contact with each other to bond the powders to each other through utilization of diffusion of atoms occurring between contact surfaces.

For example, a mixture of alumina powder and silica powder may be used as the powder P. In this case, the mixture desirably contains alumina powder having a high melting point as a main component. The configuration of the powder P is not limited thereto, and alumina powder, silica powder, and as well, zirconia powder, yttria powder, and any other material powder may be used alone or as a mixture of a plurality of kinds of these powders.

The average particle diameter of the powder P may be set to, for example, from 0.01 mm to 5 mm. From the viewpoint of improving the lubricating action of the powder Pin the pre-heating step, the powder P preferably comprises aggregate having an average particle diameter of 0.8 mm or more. The average particle diameter of the aggregate may be set to, for example, 5 mm or less. When the powder P comprises the aggregate, the content of the aggregate with respect to the powder P may be set to, for example, from 25 mass % to 75 mass %, and the average particle diameter of the powder P excluding the aggregate may be set to, for example, from 0.01 mm to 0.6 mm. For example, when the powder P is formed of alumina powder and silica powder, part of the alumina powder may be the aggregate.

The “average particle diameter” as used herein refers to a value measured by laser diffractometry, and represents a particle diameter at which a cumulative amount in a volume-based cumulative particle size distribution curve measured by laser diffractometry is 50% from a smaller particle diameter side.

The powder P is blended so as to form the bonded body 10 at 1,300° C. or more to fix the transfer container 7 of the fining bath 2 to the refractory bricks 8a and 8b. In other words, the powder P is blended so that the diffusion-bonding between the powders P is activated at 1,300° C. or more. For example, when the powder P is mixed powder of alumina powder and silica powder, the temperature at which the diffusion-bonding between the powders P is activated may be appropriately set by adjusting a mixed ratio between the powders. The mixed ratio between the alumina powder and the silica powder is set to, for example, as follows: 90 wt % of the alumina powder and 10 wt % of the silica powder, but is not limited thereto.

The homogenization bath 3 is a transfer container made of a platinum material for performing a step (homogenization step) of stirring the molten glass GM having been fined to homogenize the molten glass GM. The transfer container constituting the homogenization bath 3 is formed of a bottomed tubular container, and an outer peripheral surface thereof is covered with a refractory brick (not shown). The homogenization bath 3 comprises a stirrer 3a having a stirring blade. The homogenization bath 3 is connected to the pot 4 through the glass supply passage 6c.

The pot 4 is a container for performing a state adjustment step of adjusting the state of the molten glass GM so as to be suitable for forming. The pot 4 is presented as an example of a volume part configured to adjust the viscosity and flow rate of the molten glass GM. The pot 4 is connected to the forming body 5 through the glass supply passage 6d.

The forming body 5 is a container configured to form the molten glass GM into a desired shape. In this embodiment, the forming body 5 is configured to form the molten glass GM into a sheet shape by an overflow down-draw method. Specifically, the forming body 5 has a substantially wedge shape in a sectional shape (sectional shape perpendicular to the drawing sheet of FIG. 1), and has an overflow groove (not shown) formed on an upper portion thereof.

The forming body 5 is configured to cause the molten glass GM to overflow from the overflow groove to flow down along both side wall surfaces (side surfaces located on a front surface side and a back surface side of the drawing sheet) of the forming body 5. The forming body 5 is configured to cause the molten glasses GM having flowed down to join each other at lower end portions of the side wall surfaces. With this, a band-like sheet glass GR is formed. The band-like sheet glass GR is subjected to an annealing step S7 and a cutting step S8 described below to be formed into a sheet glass having desired dimensions.

The sheet glass obtained as described above has a thickness of, for example, from 0.01 mm to 10 mm, and is utilized for a flat panel display, such as a liquid crystal display or an OLED display, a substrate of an OLED illumination or a solar cell, or a protective cover. The forming body 5 may be used for performing any other down-draw method, such as a slot down-draw method. A glass article according to the present invention is not limited to the sheet glass GR, and encompasses a glass pipe and other glass articles having various shapes. For example, when a glass pipe is to be formed, a forming device utilizing a Danner method is arranged in place of the forming body 5.

As the composition of the sheet glass, silicate glass or silica glass is used, borosilicate glass, soda lime glass, aluminosilicate glass, or chemically tempered glass is preferably used, and alkali-free glass is most preferably used. The “alkali-free glass” as used herein refers to glass substantially free of an alkaline component (alkali metal oxide), and specifically refers to glass having a weight ratio of an alkaline component of 3,000 ppm or less. In the present invention, the weight ratio of the alkaline component is preferably 1,000 ppm or less, more preferably 500 ppm or less, most preferably 300 ppm or less.

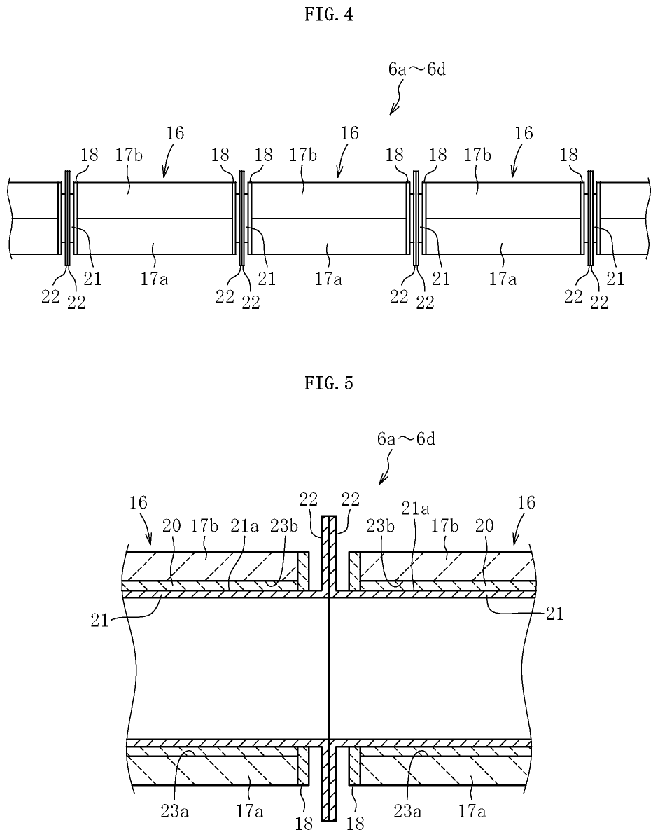

The glass supply passages 6a to 6d are configured to connect the melting bath 1, the fining bath 2, the homogenization bath (stirring bath) 3, the pot 4, and the forming body 5 in the stated order. As illustrated in FIG. 4 and FIG. 5, the glass supply passages 6a to 6d each comprise: a plurality of transfer containers 16; refractory bricks 17a and 17b configured to cover the transfer containers 16; and lid bodies 18 configured to close end portions of the refractory bricks 17a and 17b. A bonded body 20 configured to fix the transfer container 16 to each of the refractory bricks 17a and 17b is interposed between each of the refractory bricks 17a and 17b and the transfer container 16. An insulating layer may be interposed between the transfer containers 16.

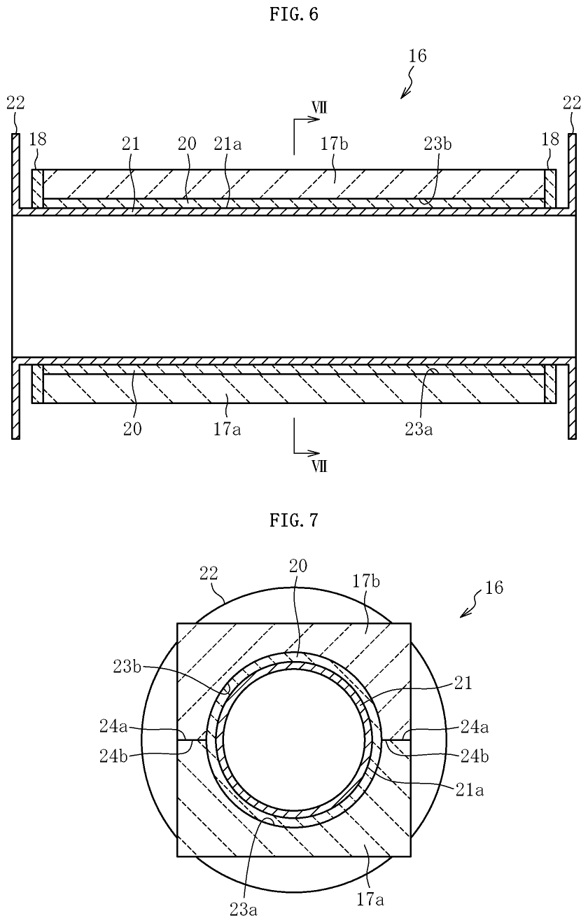

The transfer container 16 is made of a platinum material (platinum or a platinum alloy) into a tubular shape, but the configuration of the transfer container 16 is not limited thereto. The transfer container 16 only needs to have a structure having a space in an inside thereof through which the molten glass GM passes. As illustrated in FIG. 5 and FIG. 6, the transfer containers 16 each comprise: a tubular portion 21; and flange portions 22 arranged on both end portions of the tubular portion 21. The tubular portion 21 has a tubular shape, but the configuration of the tubular portion 21 is not limited thereto. The inner diameter of the tubular portion 21 is desirably set to 100 mm or more and 300 mm or less. The thickness of the tubular portion 21 is desirably set to 0.3 mm or more and 3 mm or less. The dimensions of the tubular portion 21 are not limited to the above-mentioned ranges, and are appropriately set depending on the type of the molten glass GM, the temperature, the scale of the manufacturing apparatus, and the like.

The flange portion 22 has a circular shape, but the shape of the flange portion 22 is not limited thereto. The flange portion 22 is, for example, formed integrally with the tubular portion 21 through deep drawing process. The flange portion 22 is connected to a power supply (not shown). In each of the glass supply passages 6a to 6d, as in the fining bath 2, the molten glass GM flowing through an inside of the transfer container 16 is heated with resistance heat (Joule heat) generated by applying a current through the tubular portion 21 via the flange portions 22.

The refractory bricks 17a and 17b are each made of a highly zirconia-based refractory, a zircon-based refractory, or a fused silica-based refractory, but the materials for the refractory bricks 17a and 17b are not limited thereto. The refractory bricks 17a and 17b have the same thermal expansion rates as the refractory bricks 8a and 8b according to the fining bath 2. As illustrated in FIG. 6 and FIG. 7, the refractory bricks 17a and 17b comprise a plurality of refractory bricks, and in the illustrated example, comprise a first refractory brick 17a and a second refractory brick 17b. The first refractory brick 17a is configured to support the tubular portion 21 from a lower side of the tubular portion 21. The second refractory brick 17b is configured to cover an upper part of the tubular portion 21. The first refractory brick 17a and the second refractory brick 17b may each further be divided into a plurality of refractory bricks in a longitudinal direction thereof.

The first refractory brick 17a and the second refractory brick 17b have: surfaces (hereinafter referred to as “cover surfaces”) 23a and 23b configured to cover an outer peripheral surface 21a of the tubular portion 21; and surfaces (hereinafter referred to as “abutting surfaces”) 24a and 24b configured to abut on each other. The cover surfaces 23a and 23b also have a function of holding the outer peripheral surface 21a of the tubular portion 21.

As illustrated in FIG. 7, the cover surfaces 23a and 23b are each formed of an arc-like curved surface in a sectional view so that the outer peripheral surface 21a of the tubular portion 21 is covered therewith. The radii of curvature of the cover surfaces 23a and 23b are each set to be larger than the radius of the outer peripheral surface 21a of the tubular portion 21 so that a gap (accommodation space for the bonded body 20) is formed between the cover surfaces 23a and 23b and the outer peripheral surface 21a. A distance between each of the cover surfaces 23a and 23b and the outer peripheral surface 21a of the tubular portion 21 (a difference between the radius of the outer peripheral surface 21a and each of the radii of curvature of the cover surfaces 23a and 23b) is desirably set to 7.5 mm or more. From the viewpoint of preventing creep deformation of the tubular portion 21, the distance is set to desirably 50 mm or less, more desirably 20 mm or less.

Under the state in which the abutting surface 15a of the first refractory brick 17a and the abutting surface 15b of the second refractory brick 17b are brought into contact with each other, a tubular surface configured to cover the tubular portion 21 is formed by the cover surfaces 23a and 23b of the refractory bricks 17a and 17b (see FIG. 7).

The lid body 18 has the same configuration as the lid body 9 used for the fining bath 2. The lid body 18 is configured to close each of the end portions of the refractory bricks 17a and 17b in the longitudinal direction when one surface of the lid body 18 in a thickness direction abuts on each of the end portions.

The bonded body 20 has the same configuration as the bonded body 10 of the fining bath 2. The same powder P as the powder P to be used for the bonded body 10 is used as a raw material for the bonded body 20.

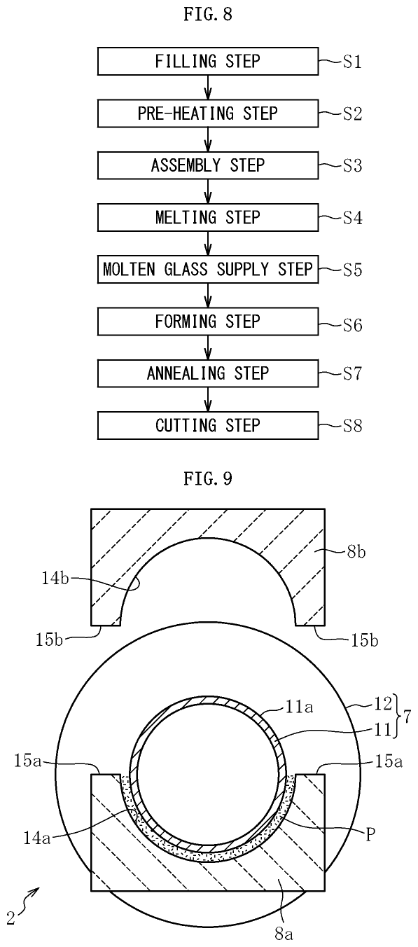

A manufacturing method for a glass article (sheet glass GR) through use of the manufacturing apparatus having the above-mentioned configuration is described below. As illustrated in FIG. 8, this method comprises: a filling step S1; a pre-heating step S2; an assembly step S3; a melting step S4; a molten glass supply step S5; a forming step S6; an annealing step S7; and a cutting step S8.

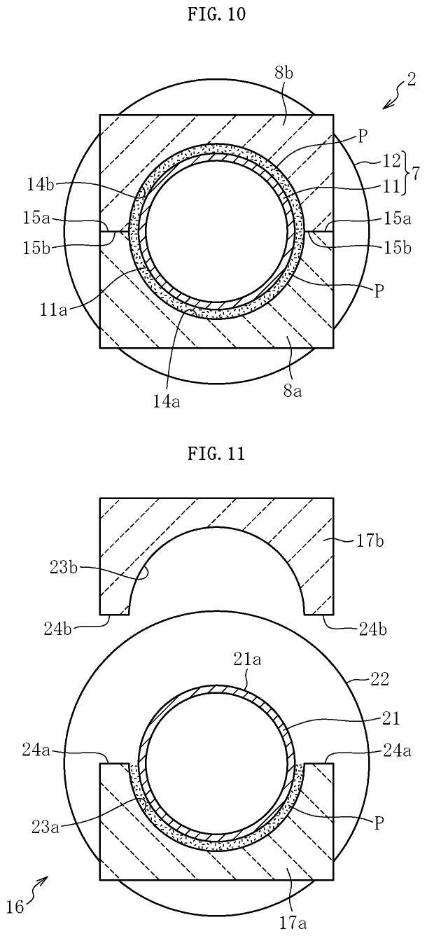

In the filling step S1, the powder P is filled in the fining bath 2. For example, as illustrated in FIG. 9, under the state in which the first refractory brick 8a and the second refractory brick 8b configured to cover the transfer container 7 of the fining bath 2 are vertically separated from each other, the powder P is filled between the cover surface 14a of the first refractory brick 8a and the outer peripheral surface 11a of the tubular portion 11 of the transfer container 7. After that, as illustrated in FIG. 10, the abutting surface 15b of the second refractory brick 8b is caused to abut on the abutting surface 15a of the first refractory brick 8a. Then, the powder P is filled in a space between an upper part of the outer peripheral surface 11a and the cover surface 14b of the second refractory brick 8b. After that, the end portions of the refractory bricks 8a and 8b are closed with the lid bodies 9.

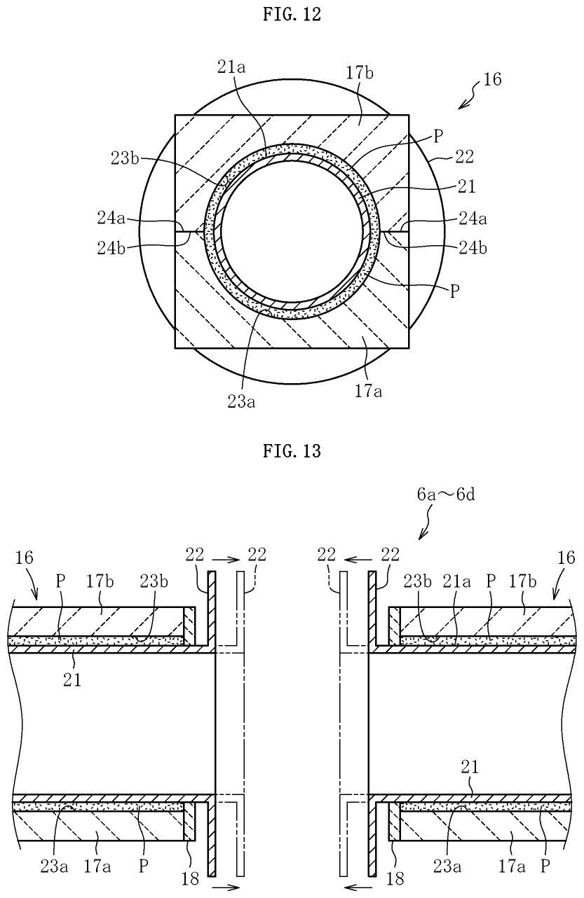

In addition, in the filling step S1, under the state in which the transfer containers 16 of each of the glass supply passages 6a to 6d are individually separated, the powder P is filled in each of the transfer containers 16. For example, as illustrated in FIG. 11, under the state in which the first refractory brick 17a and the second refractory brick 17b are vertically separated from each other, the powder P is filled between the cover surface 23a of the first refractory brick 17a and the outer peripheral surface 21a of the tubular portion 21 of the transfer container 16. After that, as illustrated in FIG. 12, the abutting surface 24a of the second refractory brick 17b is caused to abut on the abutting surface 24b of the first refractory brick 17a. Then, the powder P is filled in a space formed between an upper part of the outer peripheral surface 21a and the cover surface 23b of the second refractory brick 17b. After that, the end portions of the refractory bricks 17a and 17b are closed with the lid bodies 18. Thus, the filling step S1 is completed.

In the pre-heating step S2, the constituents 1 to 5 and 6a to 6d of the manufacturing apparatus are increased in temperature under the state in which the constituents 1 to 5 and 6a to 6d are individually separated. The case in which the fining bath 2 is increased in temperature, and the case in which the plurality of transfer containers 16 constituting each of the glass supply passages 6a to 6d are increased in temperature under the state in which the plurality of transfer containers 16 are separated from each other are described below.

In the pre-heating step S2, in order that the transfer container 7 of the fining bath 2 may be increased in temperature, a current is caused to flow through the tubular portion 11 via the flange portions 12. Similarly, in order that the transfer container 16 of each of the glass supply passages 6a to 6d may be increased in temperature, a current is caused to flow through the tubular portion 21 via the flange portions 22. With this, the transfer containers 7 and 16 are heated, and the tubular portions 11 and 21 are expanded in their axial directions (longitudinal directions) and radial directions. At this time, the powder P filled between the refractory bricks 8a and 8b and the tubular portion 11 and the powder P filled between the refractory bricks 17a and 17b and the tubular portion 21 maintain a powder state, and thus can be fluidized (moved) in the space between the tubular portion 11 and the refractory bricks 8a and 8b and the space between the tubular portion 21 and the refractory bricks 17a and 17b. When such powders P act as lubricants, the tubular portions 11 and 21 can be expanded without generating thermal stresses.

When the tubular portions 11 and 21 reach predetermined temperatures (e.g., 1,200° C. or more and less than the temperature at which the diffusion-bonding of the powder P is activated), the pre-heating step S2 is completed, and the assembly step S3 is performed. In the assembly step S3, the plurality of transfer containers 16 are connected to assemble each of the glass supply passages 6a to 6d. Specifically, the flange portion 22 of one transfer container 16 and the flange portion 22 of another transfer container 16 are caused to butt against each other. With this, the plurality of transfer containers 16 are connected and fixed to each other (see FIG. 4 and FIG. 5).

After that, the melting bath 1, the fining bath 2, the homogenization bath 3, the pot 4, the forming body 5, and the glass supply passages 6a to 6d are connected to assemble the manufacturing apparatus. Thus, the assembly step S3 is completed.

In the melting step S4, the glass raw materials supplied to the melting bath 1 are heated to generate the molten glass GM. In order to shorten a start-up time, the molten glass GM may be generated in the melting bath in advance during or before the assembly step S3.

In the molten glass supply step S5, the molten glass GM in the melting bath 1 is sequentially transferred to the fining bath 2, the homogenization bath 3, the pot 4, and the forming body 5 through the glass supply passages 6a to 6d.

In the molten glass supply step S5 (at the time of start-up of the manufacturing apparatus) immediately after the assembly step S3, the fining bath 2 (transfer container 7) and the glass supply passages 6a to 6d (transfer containers 16) are continued to be increased in temperature through application of currents through the tubular portions 11 and 21. Further, the fining bath 2 and the glass supply passages 6a to 6d are also increased in temperature when the molten glass GM having high temperature passes through the tubular portion 11 of the fining bath 2 and the tubular portions 21 of the glass supply passages 6a to 6d. Along with the increase in temperature, the powders P filled in the fining bath 2 and the glass supply passages 6a to 6d are also increased in temperature.

When the temperature of the powder P reaches the temperature at which the diffusion-bonding of the powder P is activated, the diffusion-bonding of the powder P is activated. The heating temperature of the powder P may be set to a temperature equal to or higher than the temperature at which the diffusion-bonding of the powder P is activated, and is preferably set to 1,400° C. or more. In addition, the heating temperature of the powder P is set to preferably 1,700° C. or less, more preferably 1,650° C. or less.

In this embodiment, the diffusion-bonding occurs between the alumina powders in the powder P and between the alumina powder and the silica powder in the powder P. In addition, mullite is generated from the alumina powder and the silica powder. The mullite strongly bonds the alumina powders to each other. The diffusion-bonding proceeds with time, and finally, the powder P becomes one or a plurality of bonded bodies 10 and 20. The bonded bodies 10 and 20 are brought into close contact with the tubular portions 11 and 21 and the refractory bricks 8a and 8b and 17a and 17b, respectively, and hence the movements of the tubular portions 11 and 21 with respect to the refractory bricks 8a and 8b and 17a and 17b are inhibited. With this, the tubular portions 11 and 21 are fixed to the refractory bricks 8a and 8b and 17a and 17b, respectively. The bonded bodies 10 and 20 continuously support the tubular portions 11 and 21 along with the refractory bricks 8a and 8b and 17a and 17b until the manufacturing of the sheet glass GR is completed. Times required for the powders P to entirely become the bonded bodies 10 and 20 are each desirably 24 hours or less, but are each not limited to the above-mentioned range.

Besides, the fining agent is blended in the glass raw materials, and hence, in the molten glass supply step S5, when the molten glass GM flows through the transfer container 7 of the fining bath 2, a gas (bubbles) is removed from the molten glass GM by the action of the fining agent. In addition, the molten glass GM is stirred to be homogenized in the homogenization bath 3. When the molten glass GM passes through the pot 4 and the glass supply passage 6d, the state of the molten glass GM (e.g., a viscosity or a flow rate) is adjusted.

In the forming step S6, the molten glass GM is supplied to the forming body 5 after the molten glass supply step S5. The forming body 5 is configured to cause the molten glass GM to overflow from the overflow groove to flow down along the side wall surfaces of the forming body 5. The forming body 5 is configured to cause the molten glasses GM having flowed down to join each other at lower end portions of the side wall surfaces. Thus, the sheet glass GR is formed.

After that, the sheet glass GR is subjected to the annealing step S7 involving using an annealing furnace and the cutting step S8 involving using a cutting device to be formed into predetermined dimensions. Alternatively, it is appropriate that both ends of the sheet glass GR in a width direction be removed in the cutting step S8, and then the resultant band-like sheet glass GR be taken up into a roll shape (take-up step). Thus, the glass article (sheet glass GR) is completed.

By the manufacturing method for a glass article according to this embodiment described above, in the pre-heating step S2, the transfer container 7 of the fining bath 2 and the transfer containers 16 of the glass supply passages 6a to 6d are supported by the powders P capable of being diffusion-bonded, which are filled between the transfer container 7 of the fining bath 2 and the refractory bricks 8a and 8b and between the transfer containers 16 of the glass supply passages 6a to 6d and the refractory bricks 17a and 17b, respectively. When the tubular portions 11 and 21 of the fining bath 2 and the glass supply passages 6a to 6d are expanded, the powders P can be moved (fluidized) between the tubular portions 11 and 21 and the refractory bricks 8a and 8b and 17a and 17b so that the expansion of the tubular portions 11 and 21 is not inhibited.

With this, thermal stresses that act on the tubular portions 11 and 21 in the pre-heating step S2 can be reduced to the extent possible. In addition, in the molten glass supply step S5, the powders P are diffusion-bonded to form the bonded bodies 10 and 20, and hence the tubular portions 11 and 21 can be reliably fixed with the bonded bodies 10 and 20 and the refractory bricks 8a and 8b and 17a and 17b so as not to be moved.

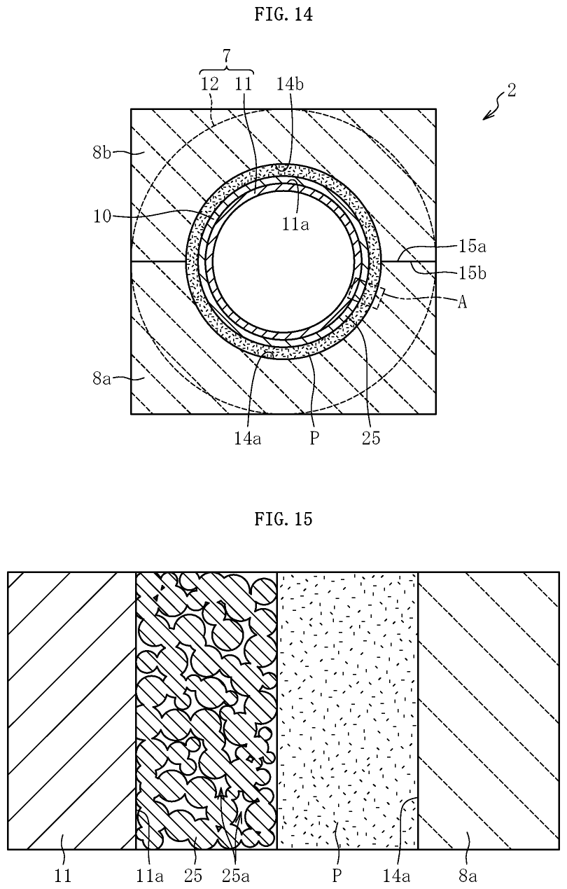

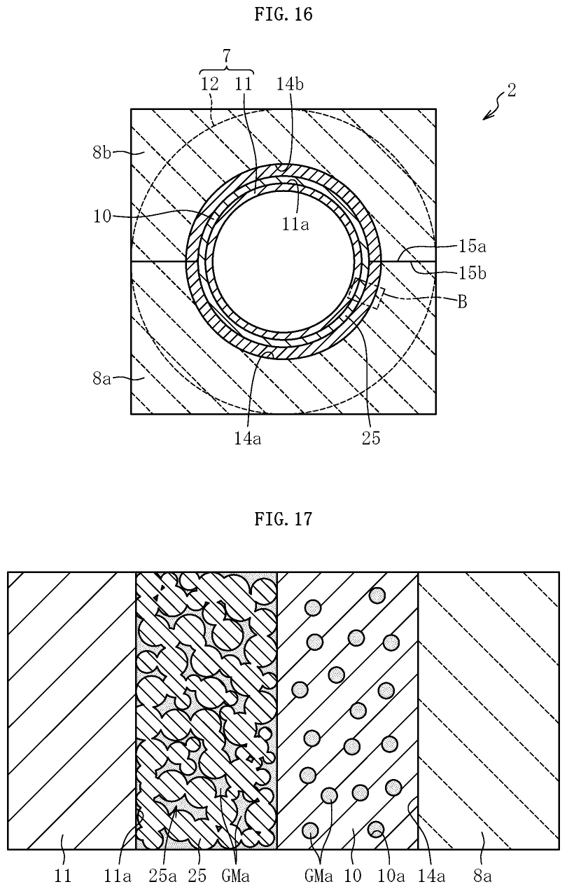

A manufacturing method and manufacturing apparatus for a glass article according to another embodiment (second embodiment) of the present invention are illustrated in FIG. 14 to FIG. 17. FIG. 14 and FIG. 15 are sectional views of a fining bath at the time of completion of the filling step (before the pre-heating step), and FIG. 16 and FIG. 17 are sectional views of the fining bath in the molten glass supply step.

As illustrated in FIG. 14 and FIG. 15, in this embodiment, the transfer container 7 of the fining bath 2 comprises a thermal spray film 25 configured to cover the outer peripheral surface 11a of the tubular portion 11. The thermal spray film 25 is a ceramic thermal spray film, and is preferably an alumina thermal spray film or a zirconia thermal spray film. In particular, the zirconia thermal spray film has higher gas barrier properties than the alumina thermal spray film, and hence is most suitable as the thermal spray film 25. The thickness of the thermal spray film 25 is preferably set to from 100 μm to 500 μm. As illustrated in FIG. 15, the thermal spray film 25 is formed through spraying of a thermal spray material, and hence is formed of a porous structure, and has a large number of micropores 25a in an inside thereof. The porosity of the thermal spray film 25 is from 10% to 35%. The thermal spray film 25 is formed on the entire outer peripheral surface 11a of the tubular portion 11. When the thermal spray film 25 is formed, the contact between the outer peripheral surface 11a of the tubular portion 11 made of a platinum material and oxygen can be reduced. Accordingly, the consumption of the transfer container 7 (the outer peripheral surface 11a of the tubular portion 11) owing to oxidation or sublimation can be reduced.

In this embodiment, with regard to the powder P, which is to be filled between the transfer container 7 and each of the refractory bricks 8a and 8b, the addition amount (content) of the silica powder is adjusted in a blending step before the filling step S1 so that the powder P forms a molten glass GMa in the molten glass supply step S5.

In the case of the powder P to be provided for the transfer container (e.g., the transfer container 16 of the glass supply passage 6a or the transfer container 7 of the fining bath 2) configured to transfer the molten glass GM having relatively high temperature in the molten glass supply step S5, the content of the silica powder is preferably reduced. In this case, the content of the silica powder in the powder P is, in terms of mass %, preferably from 5% to 30%. When the molten glass GM to be transferred has high temperature, the molten glass GMa to be generated from the powder P is reduced in viscosity to be increased in fluidity. Therefore, the content of the silica powder is reduced in order to ensure stable support of the transfer container 7 by the bonded body 10.

Meanwhile, in the case of the powder P to be provided for the transfer container (e.g., the transfer container 16 of each of the glass supply passages 6b to 6d) configured to transfer the molten glass GM having relatively low temperature, the content of the silica powder is preferably increased. In this case, the content of the silica powder in the powder P is, in terms of mass %, preferably from 40% to 70%. When the molten glass GM to be transferred has low temperature, the molten glass GMa to be generated from the silica powder has high viscosity, and the transfer container 16 can be stably supported by the bonded body 10 under the state in which the bonded body 10 includes the molten glass GMa. Accordingly, it is desired that the content of the silica powder be increased more as the molten glass GM to be transferred by each of the transfer containers 7 and 16 has lower temperature.

As illustrated in FIG. 16, the bonded body 10 is formed through diffusion-bonding of the powder P in the molten glass supply step S5. As illustrated in FIG. 17, the bonded body 10 is formed of a porous structure having a large number of pores 10a. In the molten glass supply step S5, the molten glass GMa derived from the powder P (mainly the silica powder) is generated through the adjustment of the content of the silica powder in the powder P, and the molten glass GMa is retained in the pores 10a of the bonded body 10. When the bonded body 10 includes the molten glass GMa as described above, the gas barrier properties of the bonded body 10 can be improved, and the contact between the transfer container 7 made of a platinum material (the outer peripheral surface 11a of the tubular portion 11) and oxygen can be reduced. Accordingly, the consumption of the transfer container 7 owing to oxidation or sublimation can be reduced. The bonded body 20 formed between the transfer container 16 of each of the glass supply passages 6a to 6d and the refractory bricks 17a and 17b has the same configuration as the bonded body 10. In addition, it is presumed that the molten glass GMa is generated when the bonded body 10 formed from the powder P is retained at high temperature for a long time and a silica component and the like included in the bonded body 10 are vitrified.

As illustrated in FIG. 17, in the molten glass supply step S5, part of the molten glass GMa to be generated from the powder P (mainly the silica powder) is impregnated into the pores 25a of the thermal spray film 25. With this, the gas barrier properties of the thermal spray film 25 are improved. Accordingly, the thermal spray film 25 can effectively reduce the consumption of the transfer container 7 (the outer peripheral surface 11a of the tubular portion 11).

The thermal spray film 25 according to this embodiment may be formed on each of the tubular portions 21 of the transfer containers 16 according to the glass supply passages 6a to 6d.

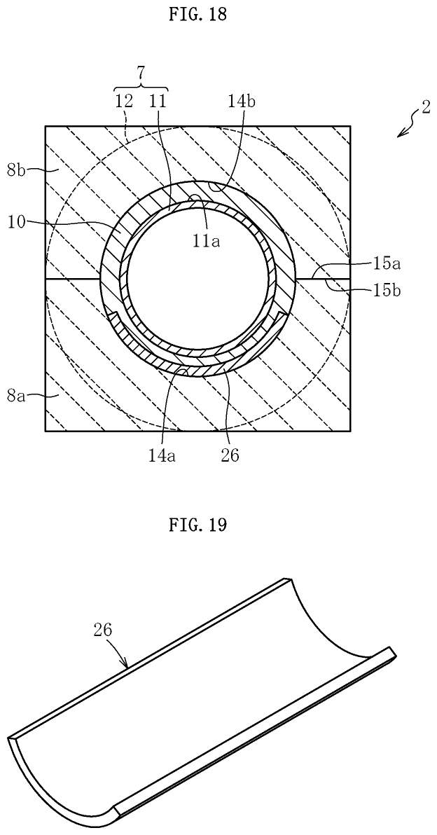

A manufacturing method and manufacturing apparatus for a glass article according to still another embodiment (third embodiment) of the present invention are illustrated in FIG. 18 to FIG. 21. A fining bath in the molten glass supply step is illustrated in FIG. 18.

The fining bath 2 comprises, in addition to the bonded body 10 interposed between the transfer container 7 and the refractory bricks 8a and 8b, a layer member 26 interposed between the transfer container 7 and the first refractory brick 8a. The layer member 26 may be formed between the transfer container 7 and the second refractory brick 8b, or may be formed between the transfer container 16 according to each of the glass supply passages 6a to 6d and the refractory bricks 17a and 17b.

The layer member 26 is, for example, made of a highly alumina-based refractory into an elongated sheet shape, but the material and shape of the layer member 26 are not limited thereto. The “highly alumina-based refractory” refers to a refractory comprising, in terms of mass %, 90% to 100% of Al₂O₃. The thermal expansion rate of the layer member 26 is higher than each of the thermal expansion rates of the refractory bricks 8a and 8b, and may be set to, for example, from 0.8% to 1.2%. A thermal expansion rate A (%) of the layer member 26 is preferably close to a thermal expansion rate B (%) of the platinum material, and specifically, a ratio A/B is preferably from 0.6 to 1.0. In this paragraph, the “thermal expansion rate” refers to a thermal expansion rate at the time of temperature increase from 0° C. to 1,300° C. The thickness of the layer member 26 is preferably set to from 3 mm to 17 mm.

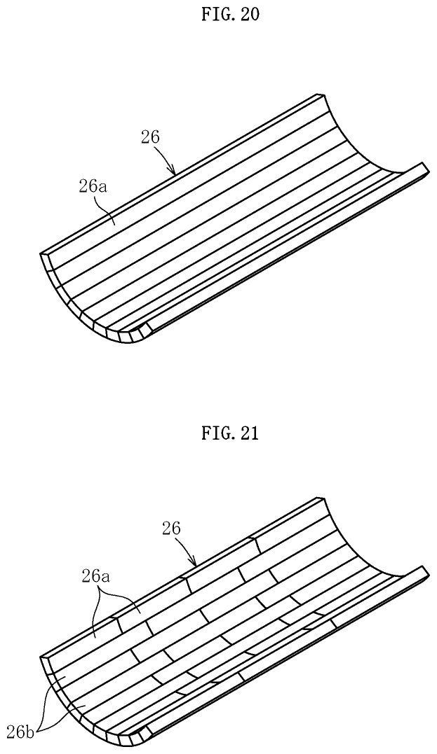

As illustrated in FIG. 19, the layer member 26 has an arc-like curved shape so as to correspond to the shapes of the tubular portion 11 of the transfer container 7 and the cover surfaces 14a and 14b of the first refractory bricks 8a and 8b. The layer member 26 is arranged so as to be brought into contact with the cover surface 14a of the first refractory brick 8a. That is, the layer member 26 is arranged at a position below the transfer container 7.

The manufacturing method for a glass article according to this embodiment is described below. In this embodiment, in the filling step S1, under the state in which the first refractory brick 8a and the second refractory brick 8b configured to cover the transfer container 7 of the fining bath 2 are vertically separated from each other, the layer member 26 is arranged (placed) so as to be brought into contact with the cover surface 14a of the first refractory brick 8a (arrangement step). Next, the powder P is filled between the cover surface 14a of the first refractory brick 8a and the outer peripheral surface 11a of the tubular portion 11 of the transfer container 7. Other procedures in the filling step S1 are the same as in the embodiment according to FIG. 1 to FIG. 9.

The powder P is capable of being fluidized and acts as a lubricant, and hence the tubular portion 11 can be relatively moved in a longitudinal direction thereof with respect to the refractory bricks 8a and 8b. In other words, the tubular portion is in the state of being permitted for expansion in the longitudinal direction of the tubular portion 11 without being fixed to the refractory bricks 8a and 8b.

In the pre-heating step S2, while the powder P arranged between the tubular portion 11 of the fining bath 2 and the refractory bricks 8a and 8b is fluidized, the tubular portion 11 is expanded in the longitudinal direction. In addition, the layer member 26 having a higher thermal expansion rate than each of the refractory bricks 8a and 8b is expanded along the longitudinal direction of the tubular portion 11. With this, the powder P is fluidized so as to accelerate the expansion of the tubular portion 11 to assist the expansion of the tubular portion 11.

The layer member 26 illustrated in FIG. 20 is formed by arranging a plurality of constituent members 26a having the same length along a circumferential direction of the tubular portion 11 side by side. The layer member 26 having the same curved shape as in the first embodiment is formed by bringing longer sides of the constituent members 26a into contact with each other. As described above, when the layer member 26 is formed by combining the plurality of constituent members 26a, an arrangement operation of the layer member 26 on the first refractory brick 8a is facilitated. In addition, the layer member 26 according to this embodiment is divided into the plurality of constituent members 26a, and hence achieves weight saving. Therefore, as compared to the case of manufacturing the layer member 26 formed of a single sheet illustrated in FIG. 19, the arrangement operation can be performed easily, and a manufacturing cost thereof can be reduced to the extent possible.

The layer member 26 illustrated in FIG. 21 is formed by arranging first constituent members 26a and second constituent members 26b having different lengths along the circumferential direction and the longitudinal direction of the tubular portion 11 side by side. Specifically, the plurality of first constituent members 26a are formed into an elongated shape by bringing end portions thereof into contact with each other, and the plurality of second constituent members 26b are formed into an elongated shape by bringing end portions thereof into contact with each other. Further, longer sides of the first constituent members 26a and the second constituent members 26b are brought into contact with each other, and thus the layer member 26 having the same curved shape as in the example illustrated in FIG. 19 is formed.

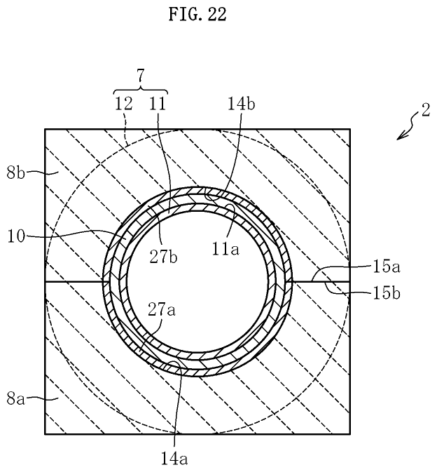

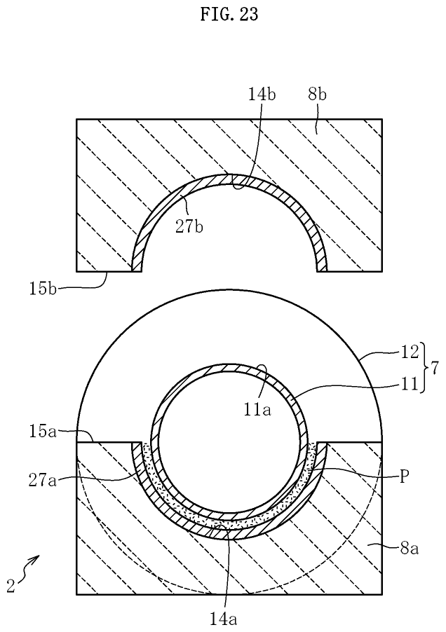

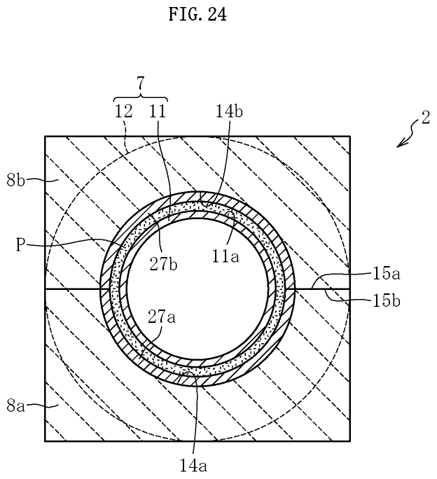

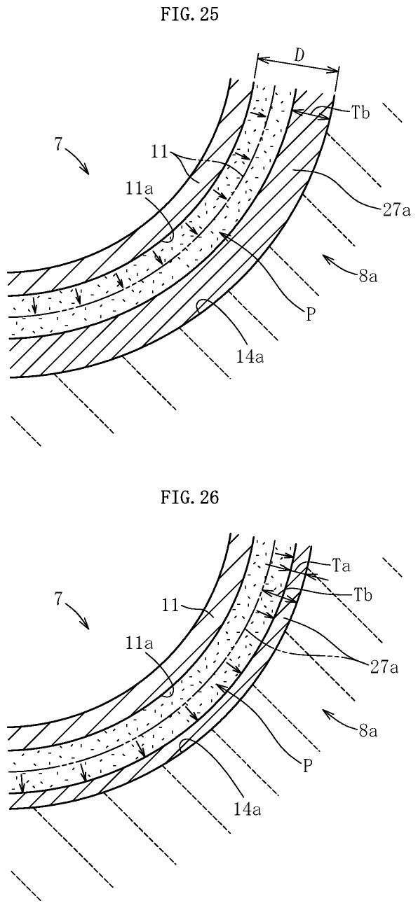

A manufacturing method and manufacturing apparatus for a glass article according to yet another embodiment (fourth embodiment) of the present invention are illustrated in FIG. 22 to FIG. 26. A fining bath in the molten glass supply step is illustrated in FIG. 22. The fining bath in the filling step is illustrated in FIG. 23 and FIG. 24. The fining bath in the pre-heating step is illustrated in FIG. 25 and FIG. 26.

The fining bath 2 comprises the bonded body 10 and absorbing members 27a and 27b between the transfer container 7 and the refractory bricks 8a and 8b, respectively. The absorbing members 27a and 27b are arranged in order to absorb the expansion of the transfer container 7 (tubular portion 11) in a radial direction.

The absorbing members 27a and 27b each have a flexible sheet shape or layer shape, and are each configured to be compression-deformable in a thickness direction thereof. The absorbing members 27a and 27b are each formed of, for example, ceramic paper. The ceramic paper is, for example, woven fabric or non-woven fabric of ceramic fibers, and zirconia paper or alumina paper is suitably used. With regard to a thickness Tb (mm) of each of the absorbing members 27a and 27b before compression deformation, a ratio (Tb/D) of the thickness Tb to a distance D (mm) between each of the cover surfaces 14a and 14b and the outer peripheral surface 11a of the tubular portion 11 at normal temperature is preferably set to from 0.1 to 0.5. Further, with regard to a thickness Ta (mm) of each of the absorbing members 27a and 27b after the compression deformation in the pre-heating step S2, a ratio (Ta/Tb) of the thickness Ta to the thickness Tb (mm) of each of the absorbing members 27a and 27b before the compression deformation is preferably set to from 0.5 to 0.9. In order to configure the absorbing members 27a and 27b to have the above-mentioned thicknesses, a plurality of sheets of thin ceramic paper and the like may be used and laminated. The porosity of each of the absorbing members 27a and 27b is preferably set to from 70% to 99%. The density of each of the absorbing members 27a and 27b may be set to, for example, from 0.1 g/cm³ to 1.0 g/cm³.

As illustrated in FIG. 23 and FIG. 24, the absorbing members 27a and 27b are arranged so as to be brought into contact with the cover surfaces 14a and 14b of the refractory bricks 8a and 8b, respectively. The absorbing members 27a and 27b comprise: a first absorbing member 27a to be brought into contact with the cover surface 14a of the first refractory brick 8a; and a second absorbing member 27b to be brought into contact with the cover surface 14b of the second refractory brick 8b. The absorbing members 27a and 27b can be deformed from the state of a flat sheet shape into a curved shape so as to follow the curved surface shapes of the cover surfaces 14a and 14b by virtue of their flexibility. In this embodiment, the absorbing members 27a and 27b have the same areas as the cover surfaces 14a and 14b, respectively, but the configurations of the absorbing members 27a and 27b are not limited thereto. For example, a plurality of absorbing members 27a and 27b having smaller areas than the cover surfaces 14a and 14b may be arranged side by side on the cover surfaces 14a and 14b, respectively.

In this embodiment, the first absorbing member 27a and the second absorbing member 27b have the same thickness, but the configurations of the absorbing members 27a and 27b are not limited thereto. The absorbing members 27a and 27b may have different thicknesses. In this case, for example, the first absorbing member 27a, which is located below the transfer container 7, may have a larger thickness than the second absorbing member 27b.

The manufacturing method for a glass article according to this embodiment is described below. In this embodiment, the powder P is filled in the fining bath 2 in the filling step S1. For example, as illustrated in FIG. 23, under the state in which the first refractory brick 8a and the second refractory brick 8b configured to cover the transfer container 7 of the fining bath 2 are vertically separated from each other, the first absorbing member 27a is arranged so as to be brought into contact with the cover surface 14a of the first refractory brick 8a. In addition, the second absorbing member 27b is arranged so as to be brought into contact with the cover surface 14b of the second refractory brick 8b (arrangement step).

Next, the powder P is filled between the cover surface 14a (first absorbing member 27a) of the first refractory brick 8a and the outer peripheral surface 11a of the tubular portion 11 of the transfer container 7. After that, as illustrated in FIG. 24, the abutting surface 15b of the second refractory brick 8b is caused to abut on the abutting surface 15a of the first refractory brick 8a. At this time, the first absorbing member 27a and the second absorbing member 27b form a tubular shape so as to cover the entire periphery of the tubular portion 11. Then, the powder P is filled in a space between an upper part of the outer peripheral surface 11a and the cover surface 14b (second absorbing member 27b) of the second refractory brick 8b. After that, the end portions of the refractory bricks 8a and 8b are closed with the lid bodies 9.

As illustrated in FIG. 25, in the pre-heating step S2, the tubular portion 11 is expanded in a radially outward direction as represented by the chain double-dashed line and the arrows. In this case, pressures acting on the powder P and the first absorbing member 27a are increased.

As illustrated in FIG. 26, when the first absorbing member 27a is pressed by the powder P owing to the expansion of the tubular portion 11, the first absorbing member 27a is compression-deformed (shrunk) so as to be reduced in thickness (a shrinkage mode is represented by the chain double-dashed line, the arrows, and the solid line). While the illustration is omitted, the second absorbing member 27b is compression-deformed (shrunk) so as to be reduced in thickness as with the first absorbing member 27a. When the absorbing members 27a and 27b are shrunk as described above, the tubular portion 11 can be expanded without an increase in pressure acting on the powder P. With this, the powder P can be suitably fluidized. In addition, when the tubular portion 11 is expanded in the longitudinal direction, an increase in frictional force between the tubular portion 11 and the powder P is reduced. Accordingly, while the tubular portion 11 is expanded in the radial direction, the tubular portion 11 can be suitably expanded also in the longitudinal direction.

In some cases, the first absorbing member 27a is pulverized after the compression deformation, and is thus further reduced in volume. Even in those cases, an increase in frictional force between the tubular portion 11 and the powder P is reduced. Accordingly, while the tubular portion 11 is expanded in the radial direction, the tubular portion 11 can be suitably expanded also in the longitudinal direction.

The present invention is not limited to the configurations of the above-mentioned embodiments. In addition, the action and effect of the present invention are not limited to those described above. The present invention may be modified in various forms within the range not departing from the spirit of the present invention.

While an example in which the powder P is diffusion-bonded after the assembly step S3 is presented in the above-mentioned embodiments, the present invention is not limited to such aspect. Part of the powder P may be diffusion-bonded in the pre-heating step S2 as long as the expansion of the transfer container is permitted in the pre-heating step S2. Similarly, the molten glass GMa may be generated from the part of the powder P in the pre-heating step S2.

While the transfer container 7 of the fining bath 2 is formed of a single transfer container 7 without being divided in the longitudinal direction in the above-mentioned embodiments, the transfer container 7 of the fining bath 2 may be divided in the longitudinal direction and be formed of a plurality of transfer containers 7 (transfer containers) as with the glass supply passages 6a to 6d illustrated in FIG. 4. In addition, while each of the glass supply passages 6a to 6d is formed of a plurality of transfer containers 16 in the above-mentioned embodiments, each of the glass supply passages 6a to 6d may be formed of a single transfer container 16 without being divided in the longitudinal direction as with the fining bath 2 illustrated in FIG. 2.

While the end portions of each of the refractory bricks 8a and 8b in the longitudinal direction are closed with the separate lid bodies 9 in the above-mentioned embodiments, the end portions of each of the refractory bricks 8a and 8b in the longitudinal direction may be closed with blankets made of inorganic fibers. Alternatively, each of the refractory bricks 8a and 8b and the lid bodies 9 may be integrated with each other. In addition, with regard to the filling of the powder P, a through hole for powder filling may be formed on each of the refractory bricks 8a and 8b, and the powder P may be filled through the through hole. In this case, the through hole may be closed with an unshaped refractory after the filling.

While the bonded bodies 10 and 20 are formed between the tubular portion 11 of the fining bath 2 and the refractory bricks 8a and 8b and between the tubular portions 21 of the glass supply passages 6a to 6d and the refractory bricks 17a and 17b in the above-mentioned embodiment, a bonded body may be formed also between the transfer container made of a platinum material and the refractory brick constituting the homogenization bath 3, and the layer member 26 or the absorbing members 27a and 27b may be interposed therebetween. As the temperature of the molten glass GM flowing through an inside is increased more, breakage and deformation of the transfer container resulting from a thermal stress generated therein become more remarkable. That is, when the present invention is applied to the transfer container through which the molten glass GM having high temperature flows, preventive effects on the breakage and deformation of the transfer container become more remarkable. Therefore, the present invention is preferably applied to the glass supply passage 6a configured to connect the melting bath 1 and the fining bath 2, the fining bath 2, the glass supply passage 6b configured to connect the fining bath 2 and the homogenization bath 3, the homogenization bath 3, and the glass supply passage 6c configured to connect the homogenization bath 3 and the pot 4, and is more preferably applied to the glass supply passage 6a and the fining bath 2.

### Examples

Now, Examples according to the present invention are described. However, the present invention is not limited to these Examples.

The inventors of the present invention performed a test for confirming the effects of the present invention, specifically, for confirming the lubricating action of the powder in the pre-heating step. In this test, test bodies according to Examples 1 to 6 were each produced by covering a transfer container made of a platinum material including a tubular portion having a circular section with refractory bricks. A gap is formed between the outer peripheral surface of the tubular portion of the transfer container and each of cover surfaces of the refractory bricks, and various powders are filled in the gap. In this test, a force (resistance value) required for moving through the tubular portion was measured.

The detailed configurations of powders used in Examples 1 to 6 are described below.

In each of Examples 1 to 5, alumina powder having a purity of 99.7 wt % was used as powder to be filled. The alumina powder has an average particle diameter of 0.11 mm. In Example 6, powder obtained by mixing alumina powder having a purity of 99.7 wt % and an average particle diameter of 0.11 mm and alumina balls (aggregate) having an average particle diameter of 1 mm at a ratio (weight ratio) of 1:1 was used.

The test results are shown in Table 1. The “powder” in Table 1 represents a main component included in the powder. The “gap” in Table 1 represents a value obtained by dividing a difference between: the diameter of a circle formed by combining the cover surface of the first refractory brick and the cover surface of the second refractory brick (cover surface inner diameter); and the outer diameter of the tubular portion of the transfer container, by 2.

The resistance value was measured as described below. Specifically, a load was applied to the tubular portion in a longitudinal direction with a load cell, and a load (kgf) at the time when the tubular portion was started to move was measured with the load cell. The resistance value (kgf/m) was calculated by dividing the measured load (kgf) by the length (m) of the tubular portion.

TABLE 1

| | Example | Example | Example | Example | Example | Example |
|---|---|---|---|---|---|---|
| | 1 | 2 | 3 | 4 | 5 | 6 |
| Powder (main component) | Alumina | Alumina | Alumina | Alumina | Alumina | Alumina |
| Addition of aggregate | Not | Not | Not | Not | Not | Added |
| | added | added | added | added | added | |
| Tubular portion outer | 252 | 252 | 252 | 252 | 252 | 252 |
| diameter (mm) | | | | | | |
| Cover surface inner | 258 | 264 | 270 | 280 | 300 | 270 |
| diameter (mm) | | | | | | |
| Gap (mm) | 3 | 6 | 9 | 14 | 24 | 9 |
| Tubular portion length | 275 | 180 | 345 | 480 | 470 | 345 |
| (mm) | | | | | | |
| Load (kgf) | 40 | 25 | 29 | 41 | 35 | 26 |
| Resistance value (kgf/m) | 145 | 139 | 84 | 85 | 74 | 75 |

In Examples 1 to 5, the same powder was used, and the gap between the tubular portion and the refractory brick was changed. In each of Examples 1 and 2, the gap between the tubular portion and the refractory brick was set to less than 7.5 mm, and it was able to be confirmed that the tubular portion was moved. In each of Examples 3 to 5, the gap between the tubular portion and the refractory brick was set to 7.5 mm or more, and the resistance value was reduced to 100 kgf/m or less. With this, it was able to be confirmed that the lubricating action of the powder was further improved when the gap between the tubular portion and the refractory brick was 7.5 mm or more.

In Example 6, the gap was set to the same value as in Example 3, and aggregate having an average particle diameter of 0.8 mm or more was added. As a result, in Example 6, the resistance value was lower than in Example 3. With this, it was able to be confirmed that the lubricating action of the powder was further improved when the powder contained the aggregate.

### REFERENCE SIGNS LIST

2 fining bath
7 transfer container
8a first refractory brick
8b second refractory brick
10 bonded body
16 transfer container
17a first refractory brick
17b second refractory brick
20 bonded body
25 thermal spray film
GM molten glass
GMa molten glass
GR glass article (sheet glass)
P powder
S1 filling step
S2 pre-heating step
S5 molten glass supply step

1. A manufacturing method for a glass article comprising transferring molten glass by a transfer container made of a platinum material and coated with a refractory brick and forming the molten glass,
the method comprising:
a filling step of interposing a powder, which is to be diffusion-bonded through heating, between the transfer container and the refractory brick;
a pre-heating step of heating the transfer container after the filling step; and
a molten glass supply step of, while heating the transfer container, causing the molten glass to pass through an inside of the transfer container after the pre-heating step,
wherein the molten glass supply step comprises diffusion-bonding the powder to form a bonded body configured to fix the transfer container to the refractory brick.

2. The manufacturing method for a glass article according to claim 1, wherein a gap between the transfer container and the refractory brick in which the powder is filled in the filling step has a width of 7.5 mm or more.

3. The manufacturing method for a glass article according to claim 1, wherein the powder to be used in the filling step comprises aggregate having an average particle diameter of 0.8 mm or more.

4. The manufacturing method for a glass article according to claim 1, wherein the transfer container is fixed to the refractory brick by the bonded body at a temperature of 1,300° C. or more.

5. The manufacturing method for a glass article according to claim 1,
wherein the bonded body comprises a porous structure, and
wherein the molten glass supply step comprises forming the bonded body comprising molten glass generated from the powder.

6. The manufacturing method for a glass article according to claim 5,
wherein the transfer container comprises a thermal spray film on an outer peripheral surface thereof, and
wherein the molten glass supply step comprises impregnating the thermal spray film with the molten glass generated from the powder.

7. The manufacturing method for a glass article according to claim 6, wherein the thermal spray film is a zirconia thermal spray film.

8. The manufacturing method for a glass article according to claim 1, wherein the powder to be used in the filling step comprises alumina powder as a main component.

9. The manufacturing method for a glass article according to claim 8, wherein the powder to be used in the filling step further comprises silica powder.

10. The manufacturing method for a glass article according to claim 9, further comprising adjusting a content of the silica powder in the powder depending on a temperature of the molten glass transferred by the transfer container.

11. A manufacturing apparatus for a glass article, comprising:
a transfer container made of a platinum material configured to transfer molten glass; and
a refractory brick configured to cover the transfer container,
wherein the manufacturing apparatus further comprises, between the transfer container and the refractory brick, a bonded body obtained by diffusion-bonding a powder.

12. A powder, which is arranged between a transfer container made of a platinum material and a refractory brick so as to fix the transfer container to the refractory brick,
the powder comprising alumina powder as a main component, and being capable of forming a bonded body by being diffusion-bonded through heating.

13. The powder according to claim 12, further comprising any one or more kinds of silica powder, zirconia powder, and yttria powder.

14. The powder according to claim 12, wherein the powder has an average particle diameter of from 0.01 mm to 5 mm.

15. The powder according to claim 12, wherein the powder comprises 25 mass % to 75 mass % of aggregate having an average particle diameter of 0.8 mm or more, with the balance having an average particle diameter of from 0.01 mm to 0.6 mm.

16. The manufacturing method for a glass article according to claim 2, wherein the powder to be used in the filling step comprises aggregate having an average particle diameter of 0.8 mm or more.

17. The manufacturing method for a glass article according to claim 2, wherein the transfer container is fixed to the refractory brick by the bonded body at a temperature of 1,300° C. or more.

18. The manufacturing method for a glass article according to claim 3, wherein the transfer container is fixed to the refractory brick by the bonded body at a temperature of 1,300° C. or more.

19. The manufacturing method for a glass article according to claim 16, wherein the transfer container is fixed to the refractory brick by the bonded body at a temperature of 1,300° C. or more.

20. The manufacturing method for a glass article according to claim 2,
wherein the bonded body comprises a porous structure, and
wherein the molten glass supply step comprises forming the bonded body comprising molten glass generated from the powder.
